(19) United States
(12) Patent Application Publication
(10) Pub. No.: US 2005/0007003 A1
(43) Pub. Date: Jan. 13, 2005

(54) Cement-free lamp base

(76) Inventors: Leif Karl Gustav, Goteberg (SE); Ulf Karl Bernhard Nilson, Vastervik (SE)

Correspondence Address: Leif Nilson, Kalltorpsgatan 4L, Goteborg, 4I652, SE

(21) Appl. No.: 10/493,986

(22) PCT Filed: Nov. 5, 2002
(86) PCT No.: PCT/SE02/02016

(30) Foreign Application Priority Data
Nov. 5, 2001 (SE) 0103659-9
Jan. 17, 2002 (SE) 0200115-4

(51) Int. Cl. H01J 5/48; H01J 5/50

(52) U.S. Cl. 313/318.09; 313/318.1

(57) ABSTRACT

Cement-free lamp base with spring locking. Lamps are normally joined with cement, which emits unhealthy chemicals when the lamp is switched on. This problem has been solved by replacing the cement with a cylindrical torsion spring (1) which tightly encloses a cylindrical part of a bulb (2) and has both of its ends connected in such a manner to a base (4) that the torsion spring (1) friction-locks the bulb (2) irrespective of whether the lamp is being screwed into or unscrewed from the socket.

The present invention relates to a device for lamps with cement-free bases which includes a cylindrical torsion spring applied outside a bulb and a driver element attached to the inside of the base.

### BACKGROUND OF THE INVENTION

In incandescent lamps bulb and base are normally joined with the aid of cement. The disadvantage of this method is that the cement is exposed to a high temperature, approximately 170 degrees Celsius in the case of a 75 watt bulb, in which connection toxic gases are emitted to the environment. The extent of the chemical emissions is shown by a recent measurement of the emissions from a standard 75 watt bulb, see articles in the newspapers: Ny Teknik “Glödlampor läcker giftiga ämnen” of Nov. 1, 2001 and Aftonbladet “Gift i lampr kan e cancer” of Nov. 3, 2001. As chemicals from overheated cement are clearly unhealthy it would be desirable to join base and bulb without cement.

Purpose and most important characteristics of the invention

The purpose of the invention is to achieve a mechanical connecting device which transmits torque from bulb to base without cracking the thin glass of the bulb. This function has been achieved with a torsion spring which tightly encloses a cylindrical part of the bulb and one outward-bent end of which hooks into an edge of a driver element in the base when the lamp is being screwed into the socket and the other outward-bent end of which hooks into another edge of the driver unit when the lamp is being unscrewed from the socket. As torque increases when the lamp is being screwed in or unscrewed the torsion spring will automatically gradually tighten its grip around the cylindrical part of the bulb and be friction-locked to this, which in turn results in reliability in the transmission of the torque from the bulb to die base in both directions of rotation. In the axial direction the base is locked to the bulb by conventional soldering of an electrical conductor into the underneath of the base.

### DESCRIPTION OF THE DRAWINGS

FIG. 1 shows a lamp with the base partially exposed.

FIG. 2 shows an enlargement of the exposed base in FIG. 1.

FIG. 3 shows a section through FIG. 1 including the end design and the end position of a spring relative to a driver element.

FIG. 4 shows a cylindrical torsion spring and its position on a bulb.

FIG. 5 shows the position of a driver element.

FIG. 6 shows a cylindrical torsion spring in two views.

FIG. 7 shows two cylindrical torsion springs in two views.

FIG. 8 shows a triple-wound cylindrical torsion spring in two views.

FIG. 9 shows two double-wound cylindrical torsion springs in two views.

FIG. 10 shows a cylindrical torsion spring in two views.

FIG. 11 shows a cylindrical torsion spring in two views.

FIG. 12 shows two cylindrical torsion springs in two views.

FIG. 13 shows two flat torsion springs in two views.

FIG. 14 shows a lamp with a partially exposed base.

FIG. 15 shows an enlargement of the exposed base in FIG. 14.

FIG. 16 shows a section through FIG. 14 including the end design of the upper spring and its connection to the base.

FIG. 17 shows a section through FIG. 14 including the end design of the lower spring and its connection to the base.

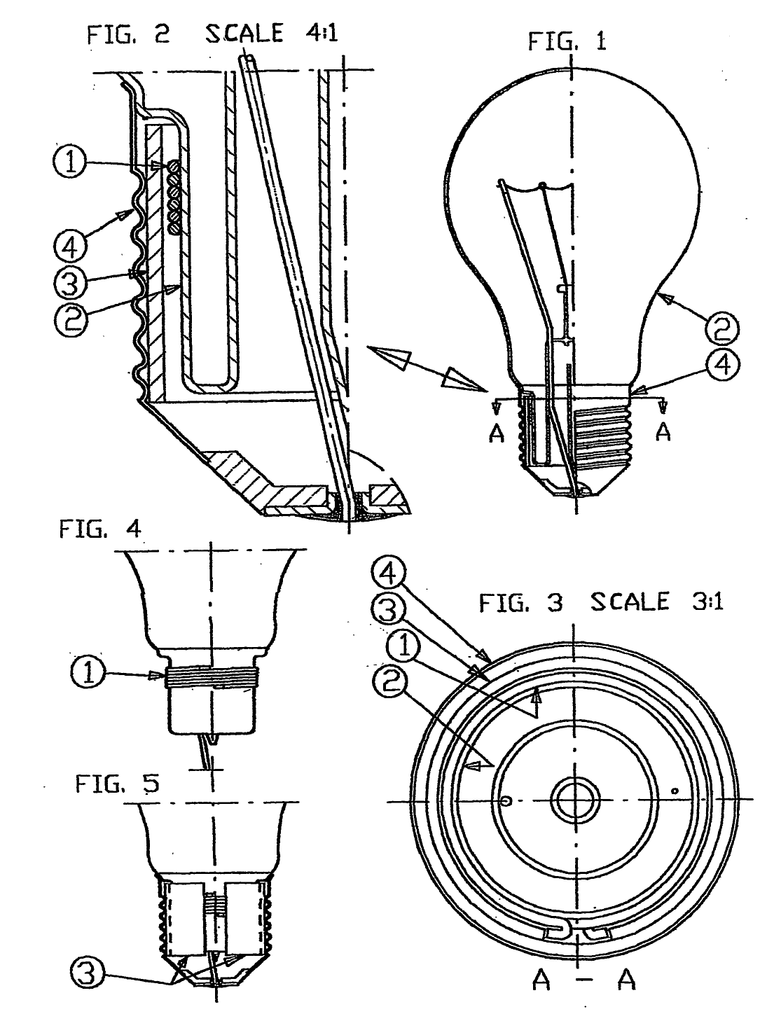

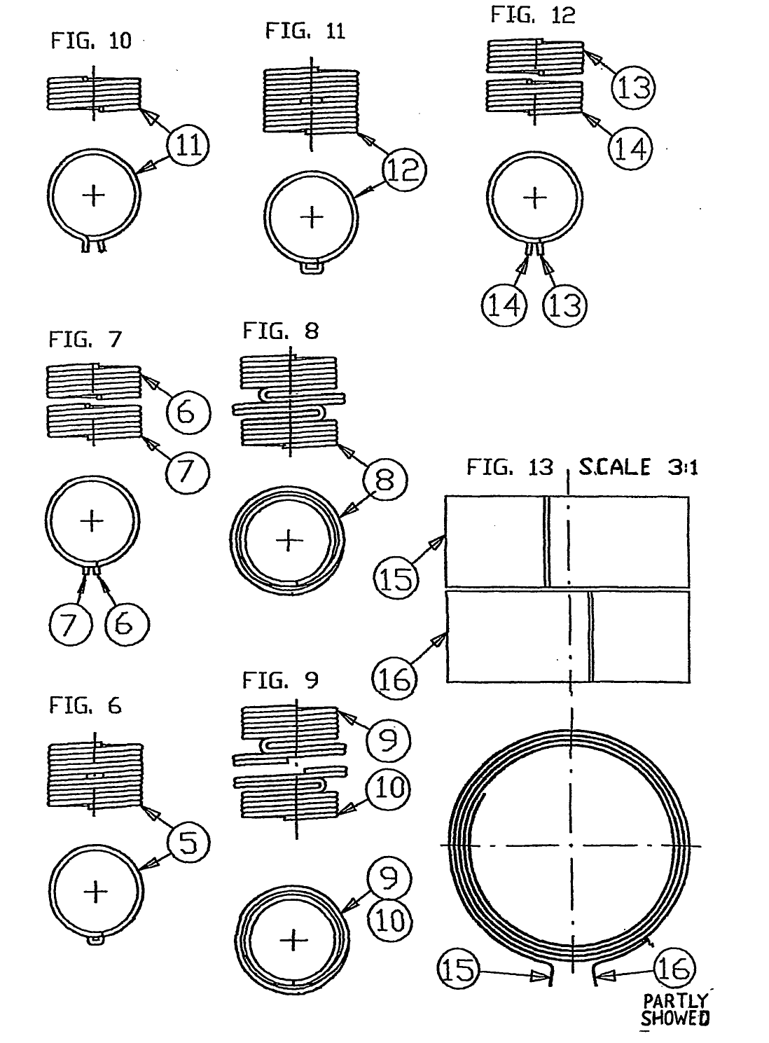

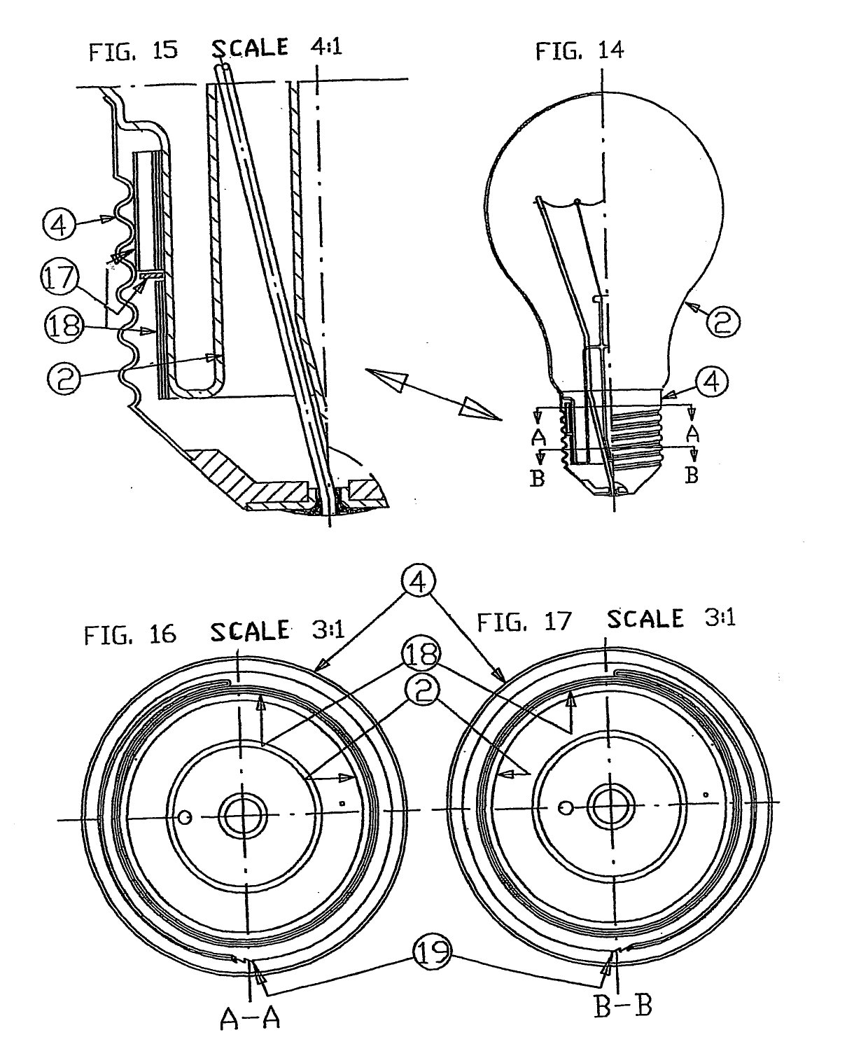

### DESCRIPTION OF PREFERRED EMBODIMENTS

In the drawing a cylindrical torsion spring is numbered 1. This encloses a cylindrical part of a bulb 2 and has its ends alternately against the edges of a driver element 3, which is attached to the inside of a base 4.

In the drawing a cylindrical torsion spring is numbered 5. This encloses a cylindrical part of a bulb 2 and has an outward bend alternately against the edges of a driver element 3, which is attached to the inside of a base 4.

In the drawing two cylindrical torsion springs mounted one after the other are numbered 6 and 7. These enclose a cylindrical part of a bulb 2 and each spring has one of its ends alternately against the edges of a driver element 3 which is attached to the inside of a base 4.

In the drawing a triple-wound cylindrical torsion spring is numbered 8. This encloses a cylindrical part of a bulb 2 and has one or more coils in close contact with the inner wall of a base 4.

In the drawing two double-wound cylindrical torsion springs mounted one after the other are numbered 9 and 10. These enclose a cylindrical part of a bulb 2 and both have one or more coils in close contact with the inner wall of a base 4.

In the drawing a cylindrical torsion spring is numbered 11. This encloses a cylindrical part of a bulb 2 and has its ends alternately in contact with the edges of a projection stamped into a base 4.

In the drawing a cylindrical torsion spring is numbered 12. This encloses a cylindrical part of a bulb 2 and has an outward bend either detachably applied to one of two projections stamped into or attached with solder or similar to a base 4.

In the drawing two cylindrical torsion springs mounted one after the other are numbered 13 and 14. These enclose a cylindrical part of a bulb 2 and each has one of its ends either loosely applied to one or more projections stamped into or attached with solder or similar to a base 4.

In the drawing two flat torsion springs mounted one after the other with one of them inverted are numbered 15 and 16. These enclose a cylindrical part of a bulb 2 and have their outer ends alternately against the edges of a driver element 3 which is attached to the inside of a base 4.

In the drawing a spacer, numbered 17, is placed between two similar flat torsion springs 18 with one of them inverted, which enclose a cylindrical part of a bulb 2 and alternately lock against a tooth 19 punched into a base 4.

1. Device for lamps with bases for joining a bulb (2) and a base (4), characterized in,
that at least one spring (1, 5-16, 18) is applied enclosing with at least an essential part of a coil the bulb (2) and that one or more coils of it or at least one outward-bent part and/or end either directly or indirectly via a driver element (3) attached in the base (4) are/is connected to the base (4) by e.g. contact, friction, soldering or some other method of attachment for the transmission of a torque on screwing of the lamp into or unscrewing of the lamp from the socket, wherein the spring (1, 5-16, 18) tightly encloses the bulb (2) for the forming of a mechanical connecting device, which by friction-locking of at least the bulb (2) transmits the torque from this to the base (4) for achieving of a cement-free base (4).

2. Device as defined in patent claim 1, characterized in,
that the spring (1), is a cylindrical torsion spring, at least one end of which is in contact with the driver element (3).

3. Device as defined in patent claim 1, characterized in,
that the spring (5) is a cylindrical torsion spring and has a local increase in radius on at least a part of a coil and that its outward-bent part is in contact with the driver element (3).

4. Device as defined in patent claim 1, characterized in,
that the springs (6) and (7) are cylindrical torsion springs and are applied one after the other and that at least one of the ends of the springs is in contact with the driver element (3).

5. Device as defined in patent claim 1, characterized in,
that the spring (8) is a cylindrical torsion spring and is triple-wound and has two diameters, and that it on the one hand encloses the bulb (2) and on the other hand has one or more coils in close contact with the base (4).

6. Device as defined in patent claim 1, characterized in,
that the springs (9) and (10) are cylindrical torsion springs and are applied one after the other and each have two diameters, and that they on the one hand enclose the bulb (2) and on the other hand have one or more coils in close contact with the base (4).

7. Device as defined in patent claim 1, characterized in,
that the spring (11) is a cylindrical torsion spring and that at least one outward-bent end of it is connected to the base (4).

8. Device as defined in patent claim 1, characterized in,
that the spring (12) is a cylindrical torsion spring and has a local increase in radius, constituting an outward-bent part, which is connected to the base (4).

9. Device as defined in patent claim 1, characterized in,
that the springs (13) and (14) are cylindrical torsion springs and are applied one after the other and that at least one of the ends of the springs is connected to the base (4).

10. Device as defined in patent claim 1, characterized in,
that the springs (15) and (16) are flat torsion springs and are applied one after the other with one of them inverted and that at least one of their outer ends is in contact with the driver element (3).

11. Device as defined in patent claim 1, characterized in,
that a spacer (17) has been placed between two similar flat torsion springs (18), applied with one of them inverted, both outer ends of which are connected to the base (4) with or without a locking tooth (19) on the base (4).
